(19) United States
(12) Patent Application Publication
(10) Pub. No.: US 2025/0251073 A1
(43) Pub. Date: Aug. 7, 2025

(54) HEATABLE FLUID LINE WITH AN INDUCTIVE INTERFACE

(71) Applicant: ContiTech Techno-Chemie GmbH, Karben (DE)

(72) Inventors: Pekka Sipilä, Aiglsbach (DE); Markus Linzmaier, Neustetten (DE); Sighard Schräbler, Karben (DE)

(73) Assignee: ContiTech Techno-Chemie GmbH, Karben (DE)

(21) Appl. No.: 18/856,046

(22) PCT Filed: Mar. 28, 2023
(86) PCT No.: PCT/DE2023/200067

§ 371 Date: Oct. 10, 2024

(30) Foreign Application Priority Data
Apr. 12, 2022 (DE) 10 2022 203 692.1

(51) Int. Cl. F16L 53/38; H05B 3/42; H05B 3/54

(52) U.S. Cl. CPC F16L 53/38; H05B 3/42; H05B 3/54; H05B 2203/021

(57) ABSTRACT

A heatable fluid line for SCR systems in motor vehicles having a line piece, a connecting piece and an inductive interface. The line piece comprises a first electrical heating conductor for heating of the line piece. The connecting piece is for connection of the fluid line to a unit or another fluid line. The connecting piece comprises a second electrical heating conductor for heating of the connecting piece. The connecting piece is connected to one end of the line piece and forms therewith a common fluid channel. The at least one inductive interface is for transfer of electrical energy to the first heating conductor and/or to the second heating conductor.

### CROSS-REFERENCE TO RELATED APPLICATIONS

This application is a National Stage Application under 35 U.S.C. § 371 of International Patent Application No. PCT/DE2023/200067 filed on Mar. 28, 2023, and claims priority from German Patent Application No. 10 2022 203 692.1 filed on Apr. 12, 2022, the disclosures of which are herein incorporated by reference in their entireties.

### BRIEF SUMMARY

The present invention relates to an electrically heatable fluid line, in particular for motor vehicles, comprising a line piece, for example in the form of a pipe or a hose, and a connecting piece connected to one of the ends of the line piece for connection of the fluid line to a unit or another fluid line.

Such fluid lines are known in particular from the field of SCR hoses (SCR: selective catalytic reduction). Thus, fluid lines can be heated by electrical heating conductors which, for example, can be arranged, in particular wrapped, around the fluid line or embedded in the fluid line. When power is supplied, the heating conductors heat up, and heat is transferred to the fluid line and to the fluid flowing through the fluid line. The heating conductors are generally protected from external influences by a protective top layer. The top layer can be, for example, in the form of a housing, a wrapped fabric tape or an overmold.

The heating conductors are usually led out of said protective top layer for contacting with a power source. The region at which the heating conductors exit from the top layer forms a weak point at which the fluid line is susceptible to delamination, leakage or other premature failures. The same problems occur when separate heating conductors need to be contacted with one another along the fluid line. This is because manufacturing frequently involves, for example, the line piece and the connecting piece being each individually provided with a heating conductor and being contacted with one another during assembly of the fluid line. In all cases, leading out the heating conductors followed by contacting is associated with a high degree of manual work.

It is an object of the present invention to provide an improved fluid line in which the aforementioned disadvantages are at least partially overcome. At the least, an alternative to existing fluid lines is be provided.

This object is achieved by a heatable fluid line having the features of claim 1. Preferred features are subject matter of the dependent claims. Further advantages and features can be found in the general description and in the exemplary embodiments.

The heatable fluid line according to the invention comprises a line piece, in particular in the form of a pipe and/or a hose, comprising a first electrical heating conductor for heating of the line piece. The fluid line further comprises a connecting piece for connection of the fluid line to a unit or another fluid line, wherein the connecting piece comprises a second electrical heating conductor for heating of the connecting piece. The connecting piece is connected to one end of the line piece and forms therewith a common fluid channel. The fluid line further comprises at least one inductive interface for transfer of electrical energy, in particular from a power source, to the first heating conductor and/or to the second heating conductor.

The inductive interface allows inductive and thus contactless transfer of at least some of the energy required for heating of at least a portion of the fluid line. This makes it possible here to dispense with leading conductors out of the top layer. Since the conductors no longer need to touch each other, it is possible to provide better encapsulation of heating conductors on the respective component, thus reducing or substantially avoiding the susceptibility to delamination, leakage or other premature failures. The process of producing such fluid lines can be considerably simplified too, since it is possible to dispense with manual contacting of the conductors connected via the inductive interface.

The fluid line may be, for example, a segment in an exhaust gas line, for example an SCR hose. The connecting piece may comprise, for example, a plug connector and/or a screw connector.

The first and/or the second heating conductor preferably comprise a metal, preferably copper. In particular, the first and/or the second heating conductor are in wire form. Preferably, the heating conductors are embedded in the line piece and/or in the connecting piece and/or surround the line piece and/or the connecting piece.

In a preferred aspect of the invention, the first heating conductor is electrically insulated from the second heating conductor, wherein formed between the line piece and the connecting piece is an inductive interface for transfer of electrical energy from the first heating conductor to the second heating conductor or vice versa. This simplifies and improves the connection between line piece and connecting piece that is otherwise particularly susceptible to faults and requires a high degree of manual work to establish it. As a result, a fluid line that is simple to produce and has a long service life is provided.

In a further preferred aspect of the invention, the line piece and/or the connecting piece comprise means for electrical contacting with an electrical power source. This makes it possible to realize a particularly compact structure of the fluid line, in which, for example, either the connecting piece or the line piece is connected to a power source and electrical energy is transferred to the respective other component via the inductive interface. Alternatively, both the connecting piece and the line piece may be connected to a power source, with, for example, connection of one of the components to a supply line and connection of the other component to an outgoing line.

In a further preferred aspect of the invention, the fluid line comprises an induction coil which is electrically insulated from the heating conductors and comprises means for electrical contacting with an electrical power source, wherein formed between the induction coil and the line piece is an inductive interface for transfer of electrical energy from the induction coil to the first heating conductor and/or formed between the induction coil and the connecting piece is an inductive interface for transfer of electrical energy from the induction coil to the second heating conductor. This allows the electrical energy for heating of the fluid line to be transferred contactlessly to the parts of the fluid line forming the fluid channel. Thus, it is possible to dispense with leading lines out of the line piece and/or the connecting piece, and this makes it possible to incorporate the heating conductors in the line piece and/or the connecting piece in a simplified manner and with better protection from external influences. The induction coil may comprise a conductive coil body. The induction coil may comprise a nonconductive housing for protection of the coil body from external influences. Preferably, the induction coil comprises a shield, shielding the coil body against external influences, for channeling of the magnetic field. The shield may be made of a material comprising a magnetically soft material having very high magnetic saturation flux density and high magnetic permeability, for example ferrite.

In a further preferred aspect of the invention, firstly, the inductive interface for transfer of electrical energy from the first heating conductor to the second heating conductor (or vice versa) and, secondly, the inductive interface for transfer of electrical energy from the induction coil to the first heating conductor and/or the inductive interface for transfer of electrical energy from the induction coil to the second heating conductor are arranged parallel to the main extension direction of the fluid channel with at least partial overlap. The overlapping inductive interfaces means that there are altogether fewer energy losses, thereby allowing heating of the fluid line with higher efficiency. Moreover, such a design allows a narrower and thus more compact construction with regard to the main extension direction of the fluid channel.

In a further preferred aspect of the invention, the first heating conductor is wound on the line piece and/or the second heating conductor is wound on the connecting piece. This allows automated application of the heating conductor to the fluid line in a particularly simple manner, for example by means of a winding machine. Moreover, the winding can define a winding direction of the heating conductors, and so at least a portion of an inductive interface can be formed by the heating conductor itself. In particular, the windings of the heating conductors and/or the induction coil are arranged mutually parallel to the main extension direction of the fluid channel with at least partial overlap for formation of at least one of the inductive interfaces. Preferably, the wound heating conductor(s) have a higher winding density in the region of the inductive interface(s) than in a region away from the inductive interface(s). This allows particularly simple and automated production of a heatable fluid line having inductive interfaces, for example by means of a winding machine. Winding density is understood to mean the number of windings in relation to a longitudinal section of the fluid line.

In a further preferred aspect of the invention, ferromagnetic particles are added to one or more non-electrically conductive parts of the fluid line in the region of the inductive interface(s). This improves inductive coupling, thereby allowing heating of the fluid line with higher efficiency. For example, ferromagnetic particles may be added to non-electrically conductive parts of the line piece, the connecting piece and/or the induction coil at those points which form an inductive interface. If the line piece is a hose, said particles may be introduced, for example, into the mixing process for the elastomeric base material.

In a further preferred aspect of the invention, conductive particles are added to one or more non-electrically conductive parts of the fluid line. The conductive particles can amplify a heating effect in the fluid line by causing increased eddy current losses and/or increased dielectric losses, which is especially advantageous for the line piece and/or the connecting piece. Furthermore, an already low conductivity of the main bodies of the fluid line also helps to dissipate charge accumulations from the respective surface, which might otherwise lead to unwanted sparking, and this is also advantageous for the induction coil. If the line piece is a hose, said particles may be introduced, for example, into the mixing process for the elastomeric base material.

In all the above-described aspects of the invention, both ends of the fluid line may also be provided with an above-described connecting piece.

The heating conductors may also be used as a data line and may thus be used, for example, for communication with or for reading of sensors (e.g., temperature sensors, flow sensors, pressure sensors, strain sensors, etc.) arranged in or on the fluid line.

The heatable fluid line according to the invention may be used in a multitude of technical solutions, especially in the automotive sector, for example as a coolant line in automobiles or as a line for cleaning exposed sensors in automobiles.

It is expressly pointed out that the above-explained aspects of the invention, each taken alone or in any technically meaningful combination with one another as well, are each combinable with the subject matter of claim 1.

### BRIEF DESCRIPTION OF THE SEVERAL VIEWS OF THE DRAWINGS

Modifications and aspects of the invention and also further advantages and details of the invention can be found in the following substantive description and the drawings. In the schematic figures:

FIG. 1 shows a sectional view of a first embodiment of the invention;

FIG. 2 shows a sectional view of a second embodiment of the invention;

FIG. 3 shows a sectional view of a third embodiment of the invention;

FIG. 4 shows a sectional view of a fourth embodiment of the invention;

FIG. 5 shows a sectional view of a line piece of the invention.

### DETAILED DESCRIPTION

Identically or similarly acting parts are—where appropriate—provided with identical reference numerals.

Individual technical features of the below-described exemplary embodiments may also be combined to form inventive subject matter in combination with above-described exemplary embodiments and with the features of the independent claims and any further claims.

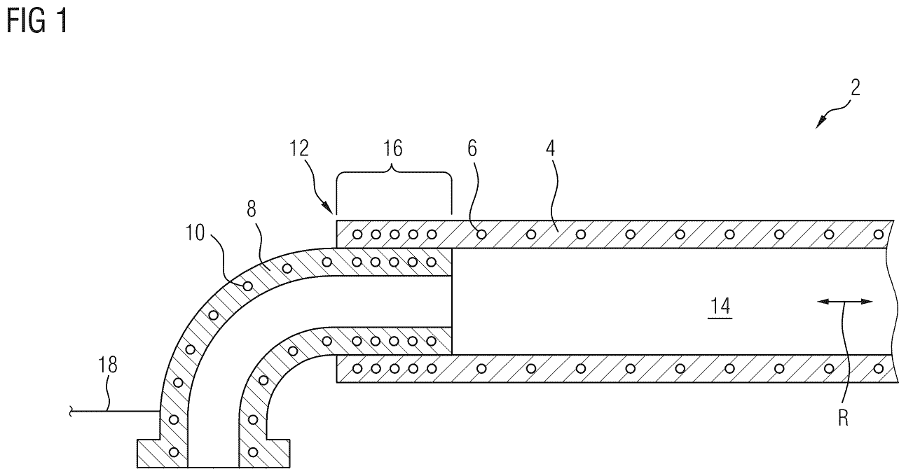

FIGS. 1 to 4 show various embodiments of a heatable fluid line 2 comprising a line piece 4 which comprises a first electrical heating conductor 6 for heating of the line piece 4, a connecting piece 8 for connection of the fluid line 2 to a unit or another fluid line (neither shown), wherein the connecting piece 8 comprises a second electrical heating conductor 10 for heating of the connecting piece 8, wherein the connecting piece 8 is connected to one end 12 of the line piece 4 and forms therewith a common fluid channel 14, and at least one inductive interface 16, 26, 28 for transfer of electrical energy to the first heating conductor 6 and/or to the second heating conductor 10. In all the embodiments shown in the figures, the first heating conductor 6 is wound on the line piece 4 and encapsulated and the second heating conductor 10 is wound on the connecting piece 8 and encapsulated, wherein the first heating conductor 6 is electrically insulated from the second heating conductor 10. Here, the wound heating conductors 6, 10 always have a higher winding density in the region of the inductive interface(s) 16, 26, 28 than in the regions away from the inductive interface(s) 16, 26, 28.

FIG. 1 shows a first embodiment of the fluid line 2 according to the invention, in which formed between the line piece 4 and the connecting piece 8 is an inductive interface 16 for transfer of electrical energy from the first heating conductor 6 to the second heating conductor 10 or vice versa. The inductive interface 16 is provided parallel to the main extension direction R of the fluid channel 14 by an overlap of the windings of the heating conductors 6, 10. The connecting piece 8 comprises means 18 for electrical contacting with a power source (not shown). Electrical heating energy can thus be transferred from the power source to the connecting piece 8 and then contactlessly to the line piece 4 via the inductive interface. Alternatively, the line piece 4 may also be connected to a power source via appropriate means, and electrical energy can be transferred contactlessly to the connecting piece 8.

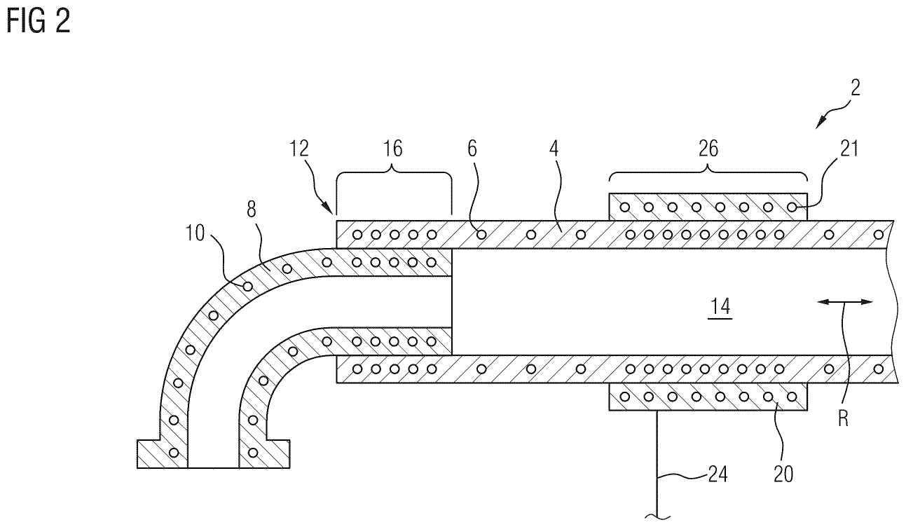

FIG. 2 shows a second embodiment of the fluid line 2 according to the invention, which differs from the first embodiment only in that neither the line piece 4 nor the connecting piece 8 are connected to the power source (not shown); instead, the electrical energy is initially transferred to an induction coil 20 via means 24 for electrical contacting with the power source. Formed between the induction coil 20 and the line piece 4 is an inductive interface 26 for transfer of electrical energy from the induction coil 20 to the first heating conductor 6. In the region of the two inductive interfaces 16, 26, the first heating conductor 6 has in each case a higher winding density than in the regions away from the inductive interfaces 16, 26.

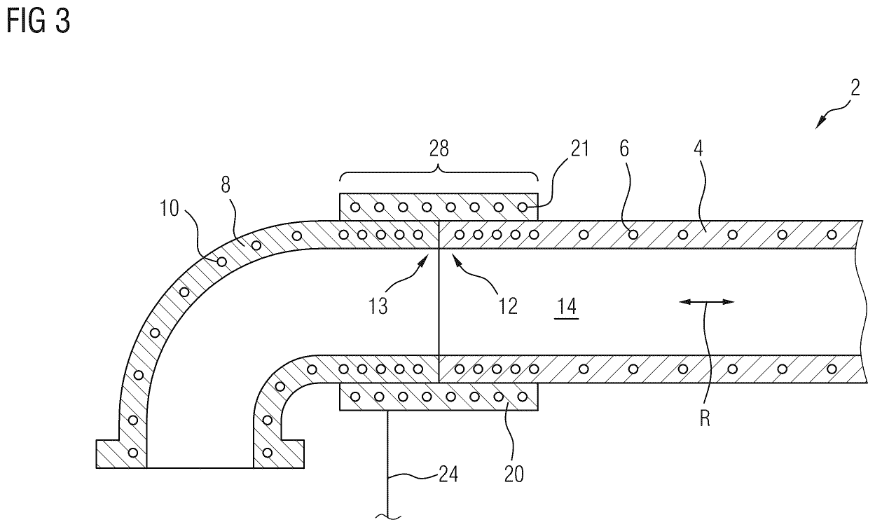

FIG. 3 shows a third embodiment of the fluid line 2 according to the invention, in which the end face of the end 12 of the line piece 4 and the end face of the end 13 of the connecting piece 8 are adjacent to each other. Formed between, firstly, the induction coil 20 and, secondly, the line piece 4 and the connecting piece 8 is an inductive interface 28 for transfer of electrical energy from the induction coil 20 to the first heating conductor 6 and the second heating conductor 10. This arrangement allows for a particularly narrow construction in a radial direction of the fluid channel 14. Power is supplied via the induction coil 20 connectable to a power source (not shown) via means 24 for electrical contracting.

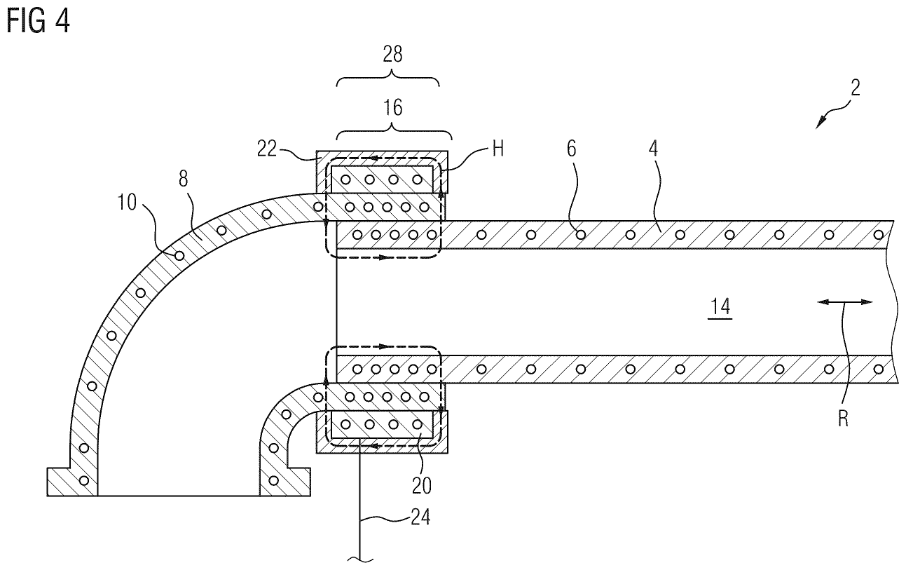

FIG. 4 shows a fourth embodiment of the fluid line 2 according to the invention, in which, [symbol] firstly, the inductive interface 16 for transfer of electrical energy from the first heating conductor 6 to the second heating conductor 10 (or vice versa) and, secondly, the inductive interface 28 for transfer of electrical energy from the induction coil 20 to the first heating conductor 6 and the second heating conductor 10 are arranged parallel to the main extension direction R of the fluid channel 14 with at least partial overlap. Owing to the overlapping inductive interfaces 16, 28, the magnetic field (see magnetic field lines H) generated by the induction coil 20 interacts on the connection point between line piece 4 and connecting piece 8. Thus, there are altogether fewer energy losses, thereby allowing heating of the fluid line 2 with higher efficiency. Moreover, such a design allows a narrower and thus more compact construction with regard to the main extension direction R of the fluid channel 14. Power is supplied via the induction coil 20 connectable to a power source (not shown) via means 24 for electrical contacting. The induction coil 20 comprises a shield 22, shielding the coil body 21 against external influences, for channeling of the magnetic field. The shield 22 is made of a material comprising a magnetically soft material having very high magnetic saturation flux density and high magnetic permeability, for example ferrite.

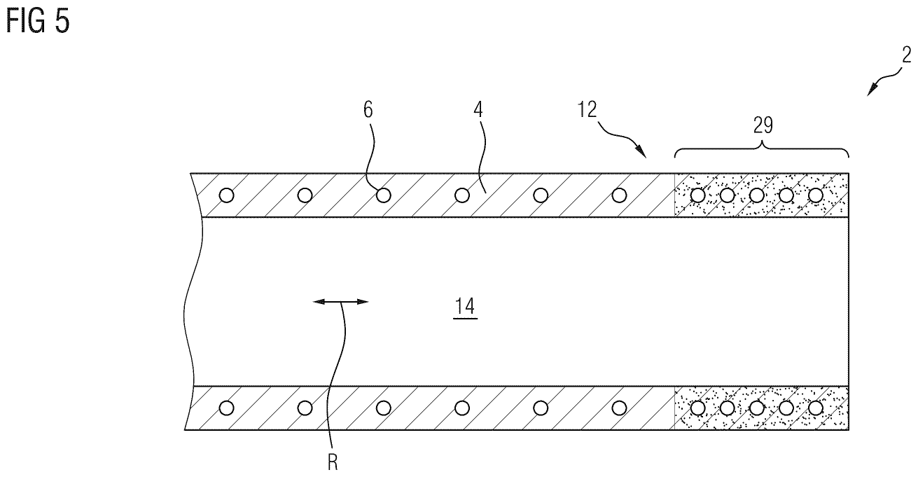

In all the embodiments, ferromagnetic particles may be added to one or more non-electrically conductive parts of the fluid line 2 in the region of the inductive interface(s) 16, 26, 28. FIG. 5 shows, by way of example, a line piece 4 according to the invention, which, in a longitudinal section 29 which is to jointly form part of an inductive interface 16, 26, 28, ferromagnetic particles are added to non-conductive parts of the line piece surrounding the heating conductor 6 (indicated by hatching). This improves inductive coupling, thereby allowing heating of the fluid line 2 with higher efficiency. The ferromagnetic particles may correspondingly also be used in the connecting piece 8 and/or the induction coil 20 in order to increase inductive coupling.

### LIST OF REFERENCE SIGNS (PART OF THE DESCRIPTION)

2 Fluid line
4 Line piece
6 First electrical heating conductor
8 Connecting piece
10 Second electrical heating conductor
12 End of the line piece 4
13 End of the connecting piece 8
14 Fluid channel
16 Inductive interface for transfer of electrical energy from the first heating conductor 6 to the second heating conductor 10
18 Means for electrical contacting of the connecting piece 8
20 Induction coil
21 Coil body
22 Shield for the induction coil 20
24 Means for electrical contacting of the induction coil 20
26 Inductive interface for transfer of electrical energy from the induction coil 20 to the first heating conductor 6
28 Inductive interface for transfer of electrical energy from the induction coil 20 to the first heating conductor 6 and the second heating conductor 10
29 Longitudinal section of the line piece 4
R Main extension direction of the fluid channel 14
H Magnetic field lines

1. A heatable fluid line for SCR systems in motor vehicles, comprising:
a line piece which comprises a first electrical heating conductor for heating of the line piece;
a connecting piece for connection of the fluid line to another fluid line, wherein the connecting piece comprises a second electrical heating conductor for heating of the connecting piece;
wherein the connecting piece is connected to one end of the line piece and forms therewith a common fluid channel; and
at least one inductive interface for transfer of electrical energy to the first heating conductor and/or to the second heating conductor.

2. The heatable fluid line as claimed in claim 1, wherein the first heating conductor is electrically insulated from the second heating conductor, and formed between the line piece and the connecting piece is an inductive interface for transfer of electrical energy from the first heating conductor to the second heating conductor or vice versa.

3. The heatable fluid line as claimed in claim 1, wherein the line piece and/or the connecting piece comprise means for electrical contacting with an electrical power source.

4. The heatable fluid line as claimed in claim 1, comprising an induction coil which is electrically insulated from the heating conductors and comprises means for electrical contacting with an electrical power source, wherein formed between the induction coil and the line piece is an inductive interface for transfer of electrical energy from the induction coil to the first heating conductor and/or formed between the induction coil and the connecting piece is an inductive interface for transfer of electrical energy from the induction coil to the second heating conductor.

5. The heatable fluid line as claimed in claim 1, wherein, firstly, the inductive interface for transfer of electrical energy from the first heating conductor to the second heating conductor or vice versa and, secondly, the inductive interface for transfer of electrical energy from the induction coil to the first heating conductor and/or the inductive interface for transfer of electrical energy from the induction coil to the second heating conductor are arranged parallel to the main extension direction of the fluid channel with at least partial overlap.

6. The heatable fluid line as claimed in claim 1, wherein the first heating conductor is wound on the line piece and/or the second heating conductor is wound on the connecting piece.

7. The heatable fluid line as claimed in claim 6, wherein the wound heating conductor(s) have a higher winding density in the region of the inductive interface(s) than in a region away from the inductive interface.

8. The heatable fluid line as claimed in claim 1, wherein ferromagnetic particles are added to one or more non-electrically conductive parts of the fluid line in the region of the inductive interface.

9. The heatable fluid line as claimed in claim 1, wherein conductive particles are added to one or more non-electrically conductive parts of the fluid line.

10. A heatable fluid line comprising:
a line piece having a first electrical heating conductor;
a connecting piece having a second electrical heating conductor and insulated from the line piece; and
an inductive interface comprising an inductive coil to transfer electrical energy to the first electrical heating conductor and the second electrical heating conductor.

11. The fluid line of claim 10, wherein the first electrical heating conductor has a higher winding density in a region near the inductive interface.

12. The fluid line of claim 11, the region comprises ferromagnetic particles within non-electrically conductive parts.

13. The fluid line of claim 12, wherein the line piece has a line piece region near the inductive interface.

14. The fluid line of claim 13, wherein the line piece region comprises ferromagnetic particles within non-electrically conductive parts.

15. The fluid line of claim 14, further comprising a power source to provide electrical power to the inductive interface.

16. The fluid line of claim 15, wherein the inductive interface further comprises a shield made of ferrite.

17. The fluid line of claim 10, wherein the inductive coil is parallel with the first electrical heating conductor.
